(19) United States
(12) Patent Application Publication
(10) Pub. No.: US 2007/0008921 A1
(43) Pub. Date: Jan. 11, 2007

(54) Wire/wireles communication system and method for providing multimedia service therein

(75) Inventors: Woo-Yong Lee, Suwon-si (KR); Sang-Jun Nam, Yongin-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/519,341

(22) Filed: Sep. 12, 2006

(30) Foreign Application Priority Data
Mar. 11, 2005 (KR) P2005-105127

(51) Int. Cl. H04Q 7/00

(52) U.S. Cl. 370/328; 713/165

(57) ABSTRACT

Provided are a wire/wireless communication system, and a method for providing multimedia service therein. The system includes a multimedia service server connecting with a mobile communication network and a wire network, and providing contents data through the wire network in response to a request for contents through the mobile communication network; a home Du connecting with the wire network, storing the contents data provided through the wire network, and providing the contents data to a terminal of a home area; and the terminal for requesting the multimedia service server for multimedia service through the mobile communication network, and receiving the contents data from the home Du.

### PRIORITY

This application claims priority under 35 U.S.C. § 119 to an application entitled “Wire/Wireless Communication System and Method for Providing Multimedia Service Therein” filed in the Korean Intellectual Property Office on Nov. 3, 2005 and assigned Serial No. 2005-105127, the contents of which are incorporated herein by reference.

### BACKGROUND OF THE INVENTION

1. Field of the Invention

The present invention relates generally to a wire/wireless communication system, and in particular, to a method for providing multimedia service in a wire/wireless communication system that can use both a wire network and a wireless network through one terminal.

2. Description of the Related Art

As wireless communication technology further develops and personal carrying information equipment becomes wireless, a wire/wireless communication system (called “one phone system”) that can use one terminal as a wire phone terminal or a wireless phone terminal depending on location is becoming popular.

The one phone system includes a Du, an access point (AP) for connecting a wire network mobile terminal, so that the mobile terminal communicates using a wire network within a wire network based area (e.g., within home), and communicates using a wireless network in areas other than the wire network based area. However, the one phone system simply integrates wire/wireless communication to merely provide a call to the terminal and makes it possible to identify the terminal, but it does not provide multimedia contents service under one phone environments.

Already there is a rapid increase in demand in the wireless mobile market for video on demand (VOD) service, such as June and Fimm, and multimedia contents together with a expected rapid increase in demand for a digital multimedia broadcasting (DMB) service

A desire of users for various and large amounts of digital contents would be satisfied by the multimedia service being provided even under one phone environments.

### SUMMARY OF THE INVENTION

It is, therefore, an object of the present invention to provide a wire/wireless communication system and a method for providing multimedia service therein, for providing various and a large amount of digital contents even under one phone environments.

It is another object of the present invention to provide a wire/wireless communication system and a method for providing multimedia service therein, for efficiently providing digital contents using a Du connecting with a wire network.

In order to achieve the above and other objects, there is provided a wire/wireless communication system. The system includes a multimedia service server for connecting with a mobile communication network and a wire network, and providing contents data through the wire network in response to a request for contents through the mobile communication network; a home Du connecting with the wire network for storing the contents data provided through the wire network, and providing the contents data to a terminal of a home area; and the terminal for requesting the multimedia service server for multimedia service through the mobile communication network, and receiving the contents data from the home Du.

In another aspect of the present invention, there is provided a method for providing multimedia service in a wire/wireless communication system. The method includes, in a terminal, requesting a multimedia service server for a specific content through a mobile communication network in response to user's request; in the multimedia service server, providing the content to a home Du of the terminal through a wire network in response to the request for the specific content; and in the home Du, storing the provided content, and providing the content to the terminal.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a construction of a wire/wireless communication system according to the present invention;

FIG. 2 schematically illustrates a method for providing multimedia service in a wire/wireless communication system according to the present invention;

FIG. 3 is a ladder diagram illustrating a method for providing multimedia service in a wire/wireless communication system according to a first embodiment of the present invention; and

FIG. 4 is a ladder diagram illustrating a method for providing multimedia service in a wire/wireless communication system according to a second embodiment of the present invention.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

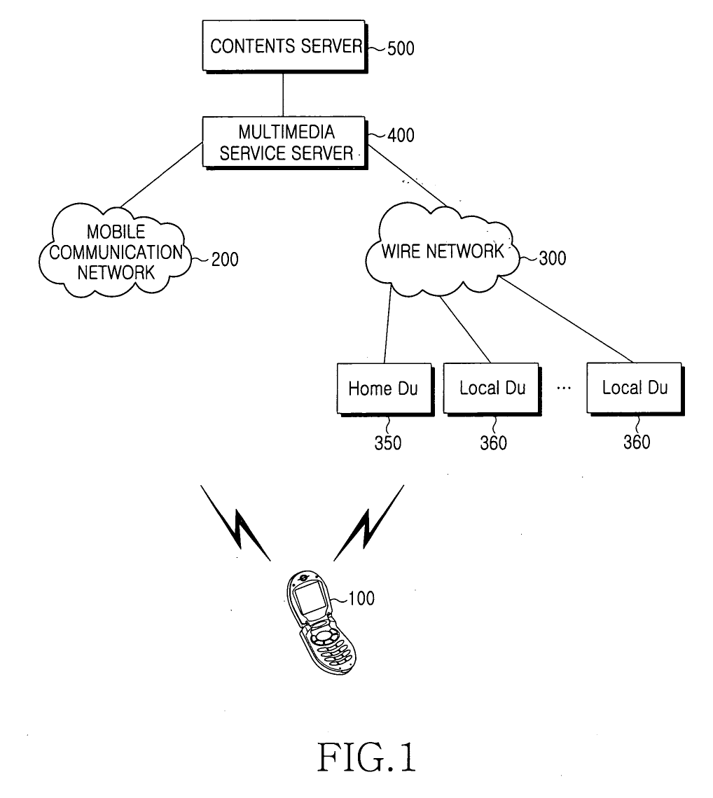

FIG. 1 illustrates a construction of a wire/wireless communication system according to the present invention. Referring to FIG. 1, the wire/wireless communication system according tithe present invention includes a subscriber terminal 100, a mobile communication network 200, a wire network 300, a home Du 350, a local Du 360, a multimedia service server 400, and a contents server 500.

The subscriber terminal (called “one phone”) 100 has both a wire phone function and a mobile phone function, and depending on time and place operates as either a wire phone terminal or a mobile phone terminal.

The mobile communication network 200, a public land mobile network (PLMN), provides a mobile communication service to the subscriber terminal 100. The mobile communication network 200 refers to all types of mobile communication networks such as a wireless LAN (WLAN) as well as a code division multiple access (CDMA) network, a global system for mobile communication (GSM) network, and a wideband code division multiple access (WCDMA) network.

The wire network 300, such as a public switched telephone network (PSTN), provides a wire phone service to the subscriber terminal 100.

The home Du 350, an access point (AP) provided within a home area of the subscriber terminal 100, connects with the wire network 300. The subscriber terminal 100 being provided within the home area, it recognizes the existence of the subscriber terminal 100, and connects the subscriber terminal 100 with the wire network 300 during the call.

The local Du 360, which is an access point (AP) provided within a local area connects with the wire network 300, so that it is also possible to connect with the home Du 350 through the wire network 300. The subscriber terminal 100 entering the local area, the local Du 360 recognizes the entrance of the subscriber terminal 100 and connects the subscriber terminal 100 with the home Du 350.

The multimedia service server 400 connects with the mobile communication terminal 200 and the wire network 300, and provides multimedia service through the mobile communication network 200 or the wire network 300. For example, upon the receipt of a digital contents request from the subscriber terminal 100, the multimedia service server 400 receives digital contents from the contents server 500, and provides the digital contents to the subscriber terminal through the mobile communication network 200 or the wire network 300.

The contents server 500 stores a variety of digital contents for multimedia service such as video on demand (VOD) data, music data, image data, and game data, and provides the digital contents requested through the multimedia service server 400.

In the wire/wireless communication system according to the present invention, the multimedia service server 400 provides the multimedia service through the entire mobile communication network 200 and the wire network 300 in order to provide the subscriber terminal 100 with the multimedia service through the wireless network 300 as well as the mobile communication network 200.

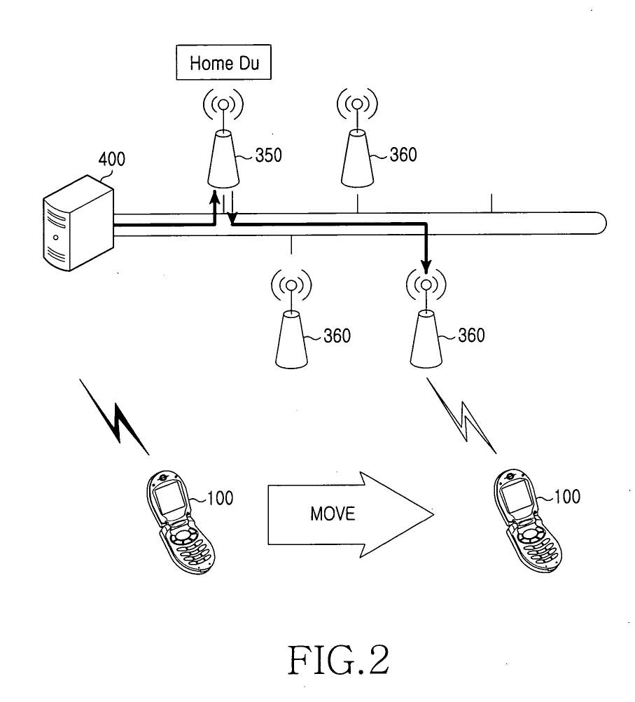

A method for providing the multimedia service in the above-described wire/wireless communication system according to the present invention will be schematically described below. FIG. 2 schematically illustrates the method for providing the multimedia service in the wire/wireless communication system according to the present invention. Referring to FIG. 2, the subscriber terminal 100 can wireless connect to the multimedia service server 400 through the mobile communication network 200. The subscriber terminal 100 connects with the multimedia service server 400 for enabling the multimedia service server 400 to provide contents information to the subscriber terminal 100. A user of the subscriber terminal 100 can select a specific content using contents information provided from the multimedia service server 400.

Upon the user selecting the specific content, the subscriber terminal 100 requests the multimedia service server 400 for the selected specific content. The specific content being requested by the subscriber terminal, the multimedia service server 400 provides the content to the home Du 350 of the subscriber terminal 100 through the wire network 300. The home Du 350 receives the content from the multimedia service server 400 through the wire network 300, and stores the received content in a specific position of a memory.

The content requested by the subscriber terminal 100 being stored in the home Du 350 is provided by the home Du 350 to the subscriber terminal 100. The home Du 350 can provide the content in either a downloading method or a streaming method.

The subscriber terminal 100 is provided with the contents from the home Du 350 using a local area wireless communication such as Bluetooth communication. Upon being positioned in the home area that is a home Du 350 area, the subscriber terminal 100 is provided with the contents from the home Du 350. Upon moving and entering a local Du 360 area, the subscriber terminal 100 is provided with the contents from the home Du 350 through the local Du 360.

Simply, the wire/wireless communication system can store the contents in the home Du 350 through the wire network 300, and provide the stored contents to the subscriber terminal 100, thereby reducing a wireless traffic and providing the multimedia service based on low cost in comparison to a conventional method in which the contents are provided to the subscriber terminal 100 through the mobile communication network 200.

The method for providing the multimedia service in the wire/wireless communication system will be described in detail. The following description is based on two exemplary embodiments of cases where a subscriber terminal 100 is positioned in a home area and where the subscriber terminal is moving to a local area.

First, a method for, when the subscriber terminal is positioned in the home area, providing multimedia service in a wire/wireless communication system according to a first exemplary embodiment of the present invention will be described in detail.

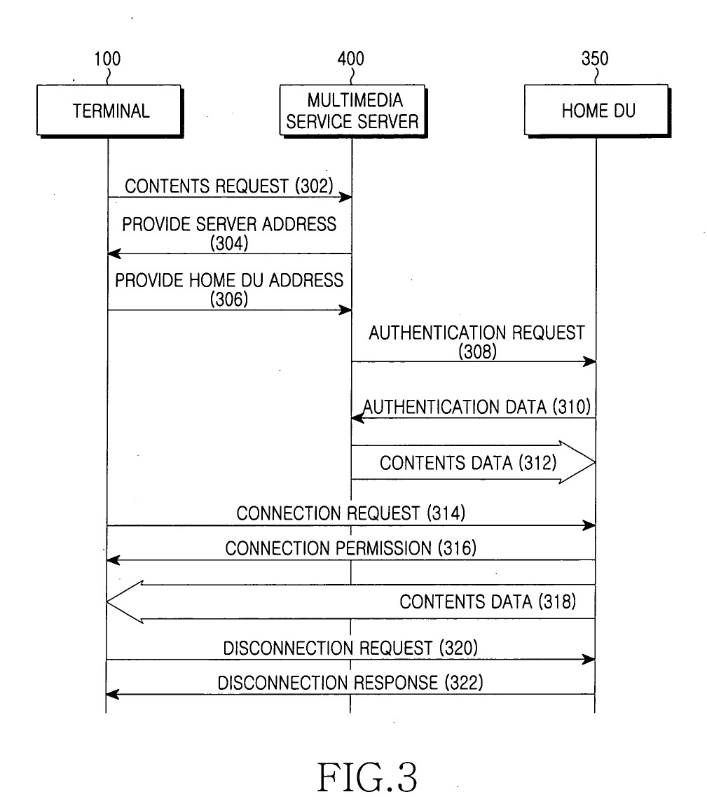

FIG. 3 is a ladder diagram illustrating the method for providing the multimedia service in the wire/wireless communication system according to the first embodiment of the present invention. Referring to FIG. 3, upon user's selection of a specific content, in Step 302, the subscriber terminal 100 requests a multimedia service server 400 for the specific content selected by a user, using a mobile communication network 200.

Upon reception of a specific content request from the subscriber terminal 100, in Step 304, the multimedia service server 400 provides an address of a contents server 500 providing the content, and requests for an address of a home Du 350 to be provided with the contents. Thus, in Step 306, the subscriber terminal 100 transmits the home Du 350 address in which it is registered, to the multimedia service server 400.

In Step 308, the multimedia service server 400 requests the home Du 350 for authentication as to whether or not the subscriber terminal 100 is a registered terminal through the wire network 300, using the home Du 350 address received from the subscriber terminal 100.

In Step 310, the home Du 350 authenticates the subscriber terminal 100, and transmits authentication data to the multimedia service server 400 through the wire network 300.

The subscriber terminal 100 being an authenticated terminal, in Step 312, the multimedia service server 400 transmits the contents data to the home Du 350 through the wire network 300.

The home Du 350 receives the contents from the multimedia service server 400, and stores the received contents in a specific position of a memory. The subscriber terminal 100 can receive the contents being stored in the home DU 350 anytime.

The subscriber terminal 100 being positioned in the home area, in Step 314, it requests the home Du 350 for connection. If so, the home Du 350 connects with the subscriber terminal 100 in Step 315, and provides its stored contents to the subscriber terminal 100 in Step 318. The home Du 350 can provide the contents in a downloading method or a streaming method.

Upon complete reception of the contents from the home Du 350, the subscriber terminal 100 requests the home Du 350 for disconnection in Step 320. In Step 322, the home Du 350 stops receiving the contents data and disconnects in response to a disconnection request from the subscriber terminal 100 and then transmits a disconnection response signal to the subscriber terminal 100.

At this time, a method for, when a subscriber terminal is positioned in a local area, providing multimedia service in a wire/wireless communication system according to a second exemplary embodiment of the present invention will be described in detail.

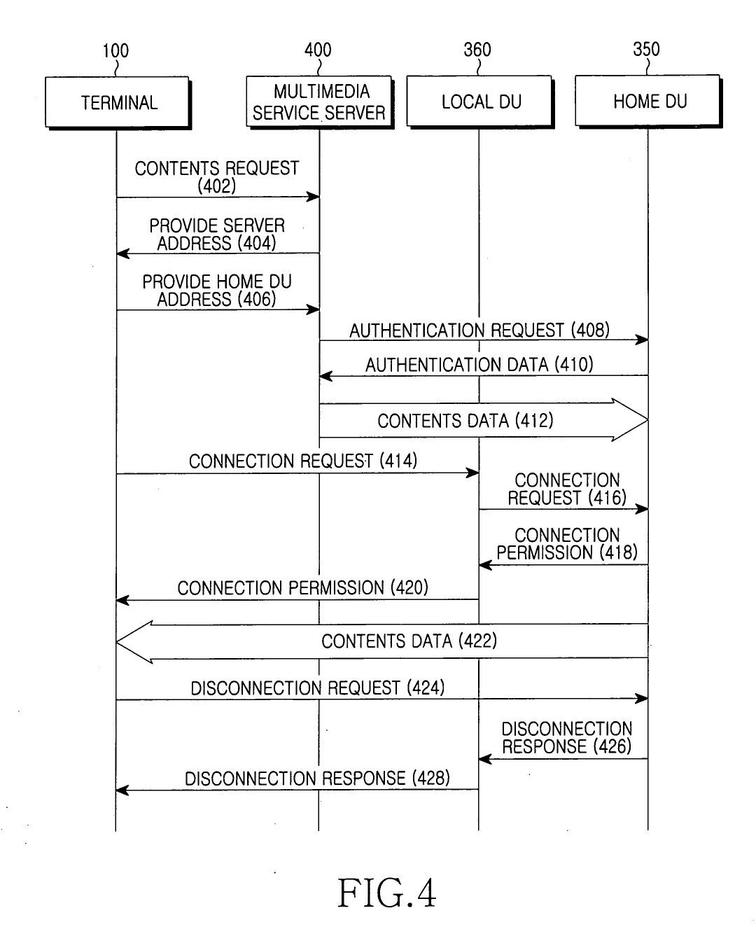

FIG. 4 is a ladder diagram illustrating the method for providing the multimedia service in the wire/wireless communication system according to the second embodiment of the present invention. Referring to FIG. 4, upon user's selection of a specific content, in Step 402, a subscriber terminal 100 requests a multimedia service server 400 for the selected specific content using a mobile communication network 200.

Upon the receipt of the specific contents request from the subscriber terminal 100, in Step 404, the multimedia service server 400 provides an address of a contents server 500 providing the contents, and requests for an address of a home Du 350 to be provided with the contents.

Thus, in Step 406, the subscriber terminal 100 transmits the home Du 350 address in which it is registered, to the multimedia service server 400.

In Step 408, the multimedia service server 400 requests the home Du 350 for authentication as to whether the subscriber terminal 100 is a registered terminal, through a wire network 300, using the home Du 350 address received from the subscriber terminal 100. In Step 410, the home Du 350 authenticates the subscriber terminal 100, and transmits authentication data to the multimedia service server 200 through the wire network 300.

The subscriber terminal 100 being an authenticated terminal, thus the multimedia service server 400 transmits contents data to the home Du 350 through the wire network 300 in Step 412.

The home Du 350 receives the contents from the multimedia service server 400, and stores the received contents in a specific position of a memory. The subscriber terminal 100 can receive the contents being stored in the home Du 350 as above anytime.

Upon moving to the local area, rather than a home area, in Step 414, the subscriber terminal 100 requests a local Du 360 of the local area in which it is positioned, for connection with the home Du 350. If so, in Step 416, the local Du 360 detects the home Du 350 of the subscriber terminal 100, and requests the home Du 350 of the subscriber terminal 100 for connection through the wire network 300.

In Step 418, the home Du 350 connects with the local Du 360 in response to the connection request from the local Du 360.

In Step 420, the local Du 360 informs the subscriber terminal 100 of connection permission in response to the connection permission from the home Du 350, and connects the subscriber terminal 100 with the home Du 350.

Upon connection with the subscriber terminal 100 by the local Du 360, in Step 422, the home Du 350 provides its stored contents to the subscriber terminal 100. The home Du 350 can provide the contents in a downloading method or a streaming method.

In step 424, upon the complete reception of the contents from the home Du 350, the subscriber terminal 100 requests the home Du 350 for disconnection. In response to the disconnection request from the subscriber terminal 100, in Step 426, the home Du 350 stops providing the contents data, and requests the disconnection with the local Du 360. If so, in Step 428, the local Du 360 disconnects with the home Du 350, and transmits a disconnection response signal to the subscriber terminal 100.

In other words, in the wire/wireless communication system according to the present invention, when the user moves to and enters a service boundary of the local Du 360 while receiving the multimedia service, the subscriber terminal 100 informs the local Du 360 of being in use of the multimedia service based on a current Du, and the subscriber terminal 100 transmits the address of the home Du 350 to the local Du 360.

Thus, the local Du 360 receives the contents to be provided to the subscriber terminal 100, from the home Du 350, and transmits the received contents to the subscriber terminal 100 using Bluetooth communication.

Moving to another area while receiving the contents from the home Du 350 through the local Du 360, the subscriber terminal 100 receives the contents from the home Du 350 through a new local Du of its movement area.

The use of the contents can be billed when the contents are stored in the home Du 350. The contents are contents in security that can be used only as a predefined user. The user can receive the contents only by connection, without the authentication on the use of the contents, between the Dus and the subscriber terminal 100, thereby being promptly provided with the contents.

The subscriber terminal 100 connects to the mobile communication network 200 at the time of an initial request for the contents, and disconnects from the mobile communication network 200 at the time of receiving the contents, thereby minimizing a mobile communication network connection time and enhancing the utilization of service based on a low communication cost.

As described above, the present invention provides the contents are provided through the Du connecting with the wire network, not through the mobile communication network, so that the traffic of the mobile communication network can be reduced and the multimedia service at a low communication cost can be provided.

The present invention has an effect that the provided contents are stored in the home Du, rather than a personal terminal, and are used according to need, thereby enhancing the efficiency of the use of the terminal memory, and the terminal does not need to employ a large capacity of memory, thereby saving a cost.

The present invention makes it possible for the user to use the multimedia service at a low communication cost, thereby activating digital contents market such as VOD contents.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A wire/wireless communication system comprising:
a multimedia service server connecting with a mobile communication network and a wire network for providing contents data through the wire network in response to a request for contents through the mobile communication network;
a home Du connecting with the wire network for storing the contents data provided through the wire network, and providing the contents data to a terminal of a home area; and
the terminal for requesting the multimedia service server for multimedia service through the mobile communication network, and receiving the contents data from the home Du.

2. The system of claim 1, wherein the home Du provides the contents data to the terminal using Bluetooth communication.

3. The system of claim 1, further comprising a local Du for transmitting the contents data to the terminal of a local area when the terminal moves to the local area.

4. The system of claim 3, wherein the home Du and the local Du connect through the wire network.

5. The system of claim 1, wherein the home Du provides the contents data to the terminal in a downloading method.

6. The system of claim 1, wherein the home Du provides the contents data to the terminal in a streaming method.

7. The system of claim 1, further comprising a contents server for storing a variety of digital contents for multimedia service, and providing the digital contents to the multimedia service server.

8. A method for providing multimedia service in a wire/wireless communication system, the method comprising steps of:
requesting, by a terminal, a multimedia service server for a specific content through a mobile communication network in response to user's request;
providing, by the multimedia service server, the content to a home Du of the terminal through a wire network in response to the request for the specific content; and
storing, by the home Du, the provided content, and providing the content to the terminal.

9. The method of claim 8, wherein the home Du provides the content to the terminal using Bluetooth communication.

10. The method of claim 8, further comprising, in a local Du, transmitting contents data provided from the home Du, to the terminal of a local area when the terminal moves to the local area.

11. The method of claim 10, wherein the home Du and the local Du connect through the wire network.

12. The method of claim 8, wherein the home Du provides the contents data to the terminal in a downloading method.

13. The method of claims 8, wherein the home Du provides the contents data to the terminal in a streaming method.

14. The method of claim 8, further comprising, in a contents server to store a variety of digital contents for multimedia service, providing the digital contents to the multimedia service server.
